(19) United States
(12) Patent Application Publication
(10) Pub. No.: US 2024/0202790 A1
(43) Pub. Date: Jun. 20, 2024

(54) SHARED ELECTRONIC BASKET WITH A HIERARCHY

(71) Applicant: Netzsch-Gerätebau GmbH, Selb (DE)

(72) Inventor: Markus Dollinger, Schwarzenbach (DE)

(21) Appl. No.: 18/537,999

(22) Filed: Dec. 13, 2023

(30) Foreign Application Priority Data
Dec. 20, 2022 (DE) 10 2022 134 051.1

(51) Int. Cl. G06Q 30/0601

(52) U.S. Cl. CPC G06Q 30/0609; G06Q 30/0633

(57) ABSTRACT

A method for ordering products by using a shared electronic basket with a hierarchy: releasing a product for the basket by at least one entity of a first plane of the hierarchy; generating an identifier for the basket by at least one entity of a second plane of the hierarchy; sharing the identifier for the basket with a plurality of entities of a third plane of the hierarchy, by at least one entity of the second plane; selecting the product by at least one entity of the plurality of entities of the third plane as a position in the basket; checking the basket by at least one entity of the second plane; and ordering according to the result of the checking by at least one entity of the first plane or at least one entity of the second plane.

### TECHNICAL FIELD OF THE INVENTION

The invention relates to a shared electronic basket and corresponding methods and systems for controlling the shared basket by means of a hierarchy, and in particular an authorization system for controlling and managing the shared basket within closed organizations.

### TECHNICAL BACKGROUND

Electronic baskets or web-based shopping carts are routinely used for processing purchasing and/or ordering transactions on electronic platforms in order to simplify these processes for a user. For example, the online marketplace eBay provides an electronic basket, in which articles can be saved and remain saved while a user can continue to shop. The user can eventually proceed to an electronic cash register and can pay for one or several of the saved articles. The payment of an order by a plurality of payers is known from the EP 3 376 457 A1.

A link between a shopping cart of a shopper and another shopping cart is also known from the US 2006/122895 A1. The shopper can be permitted with the one shopping cart to access objects in the other shopping cart by means of access privileges.

U.S. Pat. No. 6,876,977 B1 further discloses an electronic basket, which can be selectively put into a plurality of states and which makes it possible for a plurality of users to simultaneously access the basket. Additional steps comprise the allocation of different abilities to influence the state of the basket to each of the users, so that the users are permitted to simultaneously view the status of the basket and to influence the state of the basket one by one, in order to jointly select and to authorize articles for purchase

The electronic baskets or web-based shopping carts known from the prior art, however, have the disadvantage that they are not centrally managed and controlled. This thus leads to inefficient ordering processes within closed organizations, for example with redundant orders and/or multiple orders. This leads to increased costs and/or available volume discounts are not utilized even though they would be available in the case of a joint order.

It is thus one of the objects of the invention to provide a shared electronic basket and corresponding methods and systems for controlling the shared basket, in order to simplify an ordering process across an organization. The ordering process is to be capable of being managed and controlled easily.

It is a further object of the invention to make collective orders possible for one or several organizations, in order to, for example, decrease costs for shipping, such as packaging and transport, or to realize available savings, such as discounts.

It is yet a further object of the invention to improve the plannability of the orders, for example by means of connection to an enterprise resource planning (ERP) system and/or by means of an automation by using artificial intelligence.

### SUMMARY OF THE INVENTION

The invention solves the above-mentioned objects. In particular, an ordering process for several customers in one or in several departments of an organization is standardized, in order to profit from scaling effects, such as, for example, reduced technical efforts for processing orders and/or cost savings due to larger order quantities.

According to one aspect of the invention, a method for ordering products by using a shared electronic basket with a hierarchy comprising: releasing a product for the basket by at least one entity of a first plane of the hierarchy; generating an identifier for the basket by at least one entity of a second plane of the hierarchy; sharing the identifier for the basket with a plurality of entities of a third plane of the hierarchy, by at least one entity of the second plane; selecting the product by at least one entity of the plurality of entities of the third plane as a position in the basket; checking the basket by at least one entity of the second plane; and ordering according to the result of the checking by at least one entity of the first plane or at least one entity of the second plane.

According to a further aspect of the invention, a system for ordering products by using a shared electronic basket with a hierarchy, comprising: means configured for releasing a product for the basket by at least one entity of a first plane of the hierarchy; means configured for generating an identifier for the basket by at least one entity of a second plane of the hierarchy; means configured for sharing the identifier for the basket with a plurality of entities of a third plane of the hierarchy, by at least one entity of the second plane; means configured for selecting the product by at least one entity of the plurality of entities of the third plane as a position in the basket; means configured for checking the basket by at least one entity of the second plane; and means configured for ordering according to the result of the checking by at least one entity of the first plane or at least one entity of the second plane.

Further advantageous designs and further developments follow from the subclaims as well as from the description with reference to the FIGURE.

The above designs and further developments can be arbitrarily combined with one another if expedient. Further possible designs, further developments, and implementations of the invention also comprise combinations, which have not been mentioned explicitly, of features of the invention, which have been described above or will be described below with regard to the exemplary embodiments. The person of skill in the art will thereby in particular also add individual aspects as improvements or additions to the respective basic form of the present invention.

### BRIEF SUMMARY OF THE FIGURES

The present invention will be described in more detail below on the basis of the exemplary embodiment, which is specified in the schematic FIGURE, in which:

FIG. 1 shows an exemplary process of an order of a product by using a shared electronic basket with a hierarchy.

The enclosed FIGURE is to provide a wider understanding of the embodiments of the invention. It illustrates an embodiment and, in connection with the description, serves the purpose of describing principles and concepts of the invention. Other embodiments and many of the mentioned advantages follow from the FIGURE. The elements of the drawings do not serve as limitation to the specific design of the shown FIGURE.

### DESCRIPTION OF EXEMPLARY EMBODIMENTS

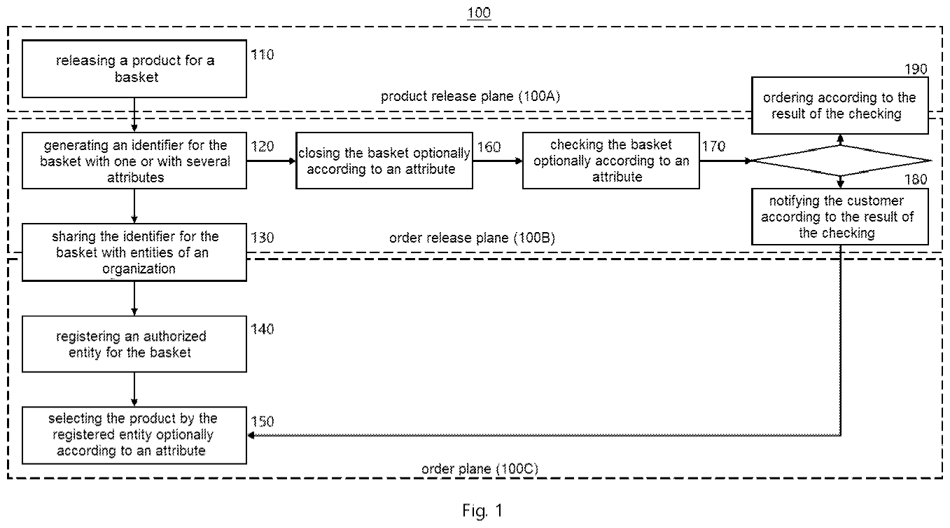

FIG. 1 shows an exemplary process 100 of an order of a product by using a shared electronic basket with a hierarchy. The process comprises a plurality of steps and the hierarchy. Each step is assigned to at least one hierarchical plane. An entity of the respective plane is authorized to perform the respective step. Several entities, individually or jointly, can also be authorized to perform the respective step. The hierarchy of the process can comprise a plurality of planes. In the preferred example shown in FIG. 1, the hierarchy comprises three planes, the product release plane 100A, the order release plane 100B, and the order plane 100C.

### Product Release Plane 100A

An entity of the product release plane 100A can be one or several natural persons of an organization and/or an artificial intelligence. The entity of the product release plane 100A is authorized to release 110 a product for a basket. An entity of the product release plane 100A can also be authorized to order according to a checked basket. An entity of the product release plane 100A can also be authorized to link its catalogues of different suppliers to the basket, for example by using a predefined standard format, which provides, for example, an electronic interface to one or to several suppliers.

### The Order Release Plane 100B

An entity of the order release plane 100A can be one or several natural persons of an organization and/or an artificial intelligence. An entity of the order release plane 100B is authorized to generate 120 an identifier (for example a “shopping cart ID”, SCID) for a basket. An entity of the order release plane 100B can further be authorized to define attributes for the basket. Attributes of the basket can be at least one or several of an order memo, of a deadline after which products can no longer be added to the basket, an order window with start and end date, a budget or purchase limits for each organization, for each suborganization, or for each customer, or the organization which is authorized to order by using the basket (see order plane 100C). An attribute can in particular be a threshold value for the quantity of a specific product, which is to be exceeded before the basket is closed.

An entity of the order release plane 100B is authorized to share 120 and to close 160 the basket, optionally under the limitations according to the defined attributes. The basket can also be closed manually at the order release plane 100B. Further changes to a closed basket can no longer be made at the order plane 100C, while changes at the order release plane 100B are still possible as part of a checking.

An entity of the order release plane 100B can thus be authorized to check 170 the basket, optionally in consideration of an attribute, such as, for example, the reaching of a threshold value. As a result of the checking 170, decisions can be made and/or actions can be initiated at the order plane 100C. Decisions can comprise, for example, a rejecting, a prioritizing, a putting on hold, a releasing of the order of a product saved as position in the basket, or a combination thereof. In addition to or instead of an entity of the order release plane 100B, an entity of the product release plane 100A can also be authorized to order 190 according to the checked basket.

An action can be, for example, a notifying 180 of a customer according to the result of the checking 170 and/or an ordering 190 according to the result of the checking.

### Order Plane 100C

An entity of the order release plane 100A can be one or several natural persons of an organization and/or an artificial intelligence. An entity of the order plane 100C can, like an entity of the order release plane 100B, be authorized to share 120 the basket, optionally under the limitations according to the defined attributes, for example with the limitation that the basket may only be shared with the entities of an organization. At the order plane 100C, however, an entity can also be authorized to share the basket with any number of further entities within and/or outside of an organization or suborganization.

An entity at the order plane 100C can register 140 for the basket. The registering 140 of the authorized entity for the basket can take place, for example, by providing an e-mail, a cost center, a department of the organization, an address of the entity, or a combination thereof. An authentication of the registered entity for verifying the authorization of the entity for the basket is also possible. A registered entity at the order plane 100C can be authorized to select 150 a product, in order to put this product into the basket as a position. The authorization can also be revoked again from the registered entity, for example by a blocking of the entity from the system. Until the closing of the basket at the order release plane 130, changes can be made to the basket at the order plane, for example a deleting of a position. At the order plane, an entity can only be authorized to change its own positions. At the order plane, an entity can further be authorized to specify attributes for a position. Attributes for a position can be at least one of a memo, of a reasoning, or of a priority.

Positions with low priority can be put on hold at the order release plane 100B. If changes are made to the basket at the order release plane 100B, e.g. an order is put on hold or rejected, an entity at the order plane 100C can be informed about the change at the order release plane 100B by means of the registration.

### Exemplary Chronological Method

A method for ordering by using a shared electronic basket with a hierarchy can comprise one or several of the following steps: Releasing 110 a product for a basket by an entity of a first plane 100A of a hierarchy; generating 120 an identifier for the basket with one or with several attributes by an entity of a second plane 100B of the hierarchy; sharing 130 the identifier for the basket with a plurality of entities of a third plane 100C of the hierarchy, by at least one entity of the second plane 100B; registering 140 for the basket by an entity of the third plane 100C. Selecting 150 the product by the registered entity of the third plane 100C; closing 160 the basket by an entity of the second plane 100B; checking 170 the basket by an entity of the second plane 100B; notifying 180 the entity of the third plane 100C according to the result of the checking 170 by an entity of the second plane 100B; and ordering 190 according to the result of the checking 170 by an entity of the first plane 100A or of the second plane 100B.

A method can also include a generating of a shared electronic basket with a hierarchy based on an earlier shared electronic basket with a hierarchy (not shown in FIG. 1). For example, the above-described exemplary method can include this step.

The generating of a basket can also comprise an analyzing of an ordering behavior of entities or of groups of entities of a plane of a hierarchy, in order to create order proposals, by using artificial intelligence. Order proposals can be associated, for example, with time intervals or with an annual supply, or a behavior of one or of several entities. Fixed procurement cycles can optionally also be set in order to automatically generate a basket. Entities of the third plane 100C can be informed of the generated basket automatically and recurrently.

### Exemplary Computer Program Products

One or several of the above-described method steps can be implemented in a computer program product. The method steps can in particular be implemented in a plane of the hierarchy in a respective computer program product, in order to use and or to control the basket according to the authorizations of the respective plane.

### Exemplary System

A distributed system for carrying out the method for ordering by using a shared electronic basket with a hierarchy can be completely or partially cloud-based and/or can comprise one or several processor and one or several communicatively coupled, non-volatile computer-readable storage media, which are configured individually or as a whole, in order to perform one or several of the above-described method steps. Individual devices of the system can in particular be configured individually, in order to perform method steps of a plane of the hierarchy, in order to use or to control the basket according to the authorizations of the respective plane.

Various features for improving the stringency of the illustration have been described and/or summarized in a simplified manner in one or several examples in the preceding detailed description. It should be clear thereby, however, that the above description is only of an illustrative, but in no way of a limiting nature. It serves the purpose of covering all alternatives, modifications, and equivalents of the various features and exemplary embodiments. Many other examples will be immediately and directly clear to the person of skill in the art based on his expert knowledge in consideration of the above description.

The exemplary embodiments have been selected and described in order to be able to illustrate the principles, on which the invention is based, and its application options in practice in the best possible way. Persons of skill in the art can thus optimally modify and use the invention and its various exemplary embodiments with regard to the intended purpose.

In the claims as well as the description, the terms “including” and “having” are used as linguistically neutral terms for the corresponding term “comprising” A use of the term “a” is to furthermore not generally exclude a plurality of features and components described in this way.

1. A method for ordering products by using a shared electronic basket with a hierarchy, comprising:
releasing a product for the basket by at least one entity of a first plane of the hierarchy;
generating an identifier for the basket by at least one entity of a second plane of the hierarchy;
sharing the identifier for the basket with a plurality of entities of a third plane of the hierarchy, by at least one entity of the second plane;
selecting the product by at least one entity of the plurality of entities of the third plane as a position in the basket;
checking the basket by at least one entity of the second plane; and
ordering according to the result of the checking by at least one entity of the first plane or at least one entity of the second plane.

2. The method according to claim 1, whereby the generating of the identifier comprises:
defining attributes for the basket by at least one entity of the second plane.

3. The method according to claim 1, whereby the defining of attributes for the basket comprises:
defining a threshold value for the quantity, which is to be ordered, of the product.

4. The method according to claim 1, further comprising:
registering for the shared basket by the at least one entity of the third plane.

5. The method according to claim 1, further comprising:
closing the basket by the at least one entity of the second plane.

6. The method according to claim 1, whereby the checking of the basket comprises at least one of:
rejecting a position in the basket;
prioritizing a position in the basket;
holding back a position in the basket; and
releasing a position in the basket.

7. The method according to claim 1, further comprising:
notifying the at least one entity of the plurality of entities of the third plane according to the result of the checking.

8. The method according to claim 1, further comprising:
analyzing an ordering behavior of the at least one entity of the plurality of entities of the third plane by using artificial intelligence.

9. The method according to claim 8, further comprising:
creating an order proposal based on a result of the analyzing of the ordering behavior.

10. A system for ordering products by using a shared electronic basket with a hierarchy, comprising:
means configured for releasing a product for the basket by at least one entity of a first plane of the hierarchy;
means configured for generating an identifier for the basket by at least one entity of a second plane of the hierarchy;
means configured for sharing the identifier for the basket with a plurality of entities of a third plane of the hierarchy, by at least one entity of the second plane;
means configured for selecting the product by at least one entity of the plurality of entities of the third plane as a position in the basket;
means configured for checking the basket by at least one entity of the second plane; and
means configured for ordering according to the result of the checking by at least one entity of the first plane or at least one entity of the second plane.

11. The method according to claim 2, whereby the defining of attributes for the basket comprises:
defining a threshold value for the quantity, which is to be ordered, of the product.

12. The method according to claim 2, further comprising:
registering for the shared basket by the at least one entity of the third plane.

13. The method according to claim 2, further comprising:
closing the basket by the at least one entity of the second plane.

14. The method according to claim 2, whereby the checking of the basket comprises at least one of:
rejecting a position in the basket;
prioritizing a position in the basket;
holding back a position in the basket; and
releasing a position in the basket.

15. The method according to claim 2, further comprising:
notifying the at least one entity of the plurality of entities of the third plane according to the result of the checking.

16. The method according to claim 2, further comprising:
analyzing an ordering behavior of the at least one entity of the plurality of entities of the third plane by using artificial intelligence.

17. The system according to claim 10 wherein said configured means is a programmed computer.
